(19) United States
(12) Patent Application Publication
(10) Pub. No.: US 2009/0084362 A1
(43) Pub. Date: Apr. 2, 2009

(54) CATALYST MATERIAL FOR EVAPORATIVE EMISSION CONTROL SYSTEM

(76) Inventors: Wing Chan, Novi, MI (US); Kevin Mulkeran, Holly, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/863,981

(22) Filed: Sep. 28, 2007

(51) Int. Cl. F02M 33/02

(52) U.S. Cl. 123/519

(57) ABSTRACT

Compositions for use in evaporative emission control systems are disclosed and described. The compositions include a fuel adsorbent material mixed with a catalyst. The catalyst is polymeric and has a specific heat that is higher than the specific heat of the fuel adsorbent material.

### FIELD

The present disclosure relates to materials used in evaporative emission control systems, and more particularly, concerns a polymeric catalyst for such systems.

### BACKGROUND

Many automotive vehicles are equipped with an evaporative emission control system that prevents volatile components in the fuel tank from escaping to the atmosphere during periods of vehicle inactivity. Typical evaporative emission control systems include a canister comprising a bed of activated carbon that serves as fuel vapor adsorbent. The canister is connected to the fuel tank and engine air intake such that when the engine is not running, volatile components from the fuel tank flow through the canister and are adsorbed on the activated carbon. Thus, the hydrocarbon content of any gas discharged to the atmosphere is significantly reduced. When the engine is operated, atmospheric air is periodically introduced in the canister, resulting in the desorption of adsorbed hydrocarbon vapor components from the activated carbon so that the activated carbon can again be used during the next cycle of vehicle inactivity. The desorbed hydrocarbons are routed to the engine where they are combusted.

Activated carbon is typically an expensive component that accounts for a significant proportion of the evaporative emission control system's overall cost. Thus, it is desirable to improve the efficiency with which the fuel vapor adsorbent adsorbs and desorbs vapor components. Thus, a need has arisen for an evaporative emission control system that addresses the foregoing.

### BRIEF DESCRIPTION OF THE DRAWINGS

FIG. 1 depicts an evaporative emission control system connected to a vehicle engine and fuel system during a loading/adsorption phase in which the engine is not operative.

FIG. 2 depicts the evaporative emission control system of FIG. 1 during a regeneration/desorption phase in which the engine is operative.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

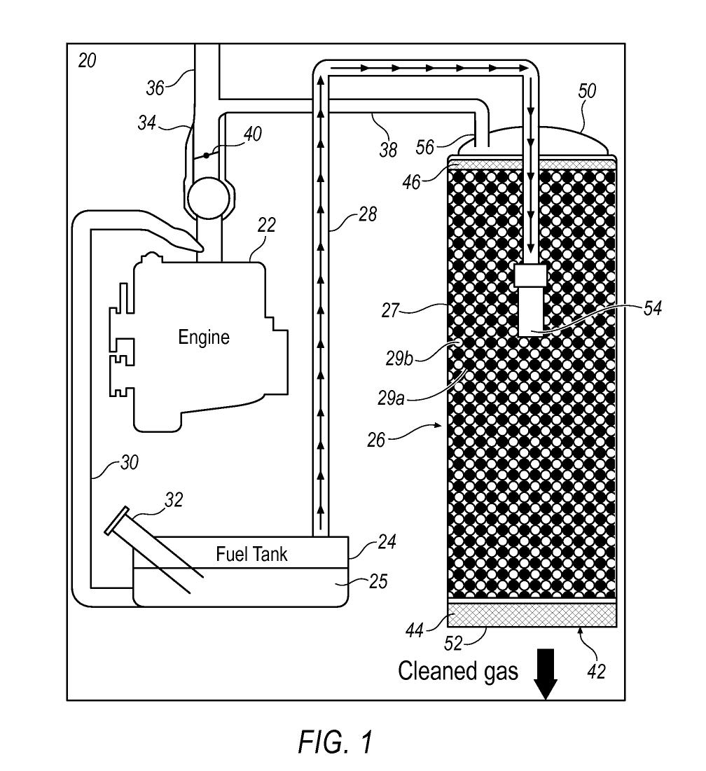

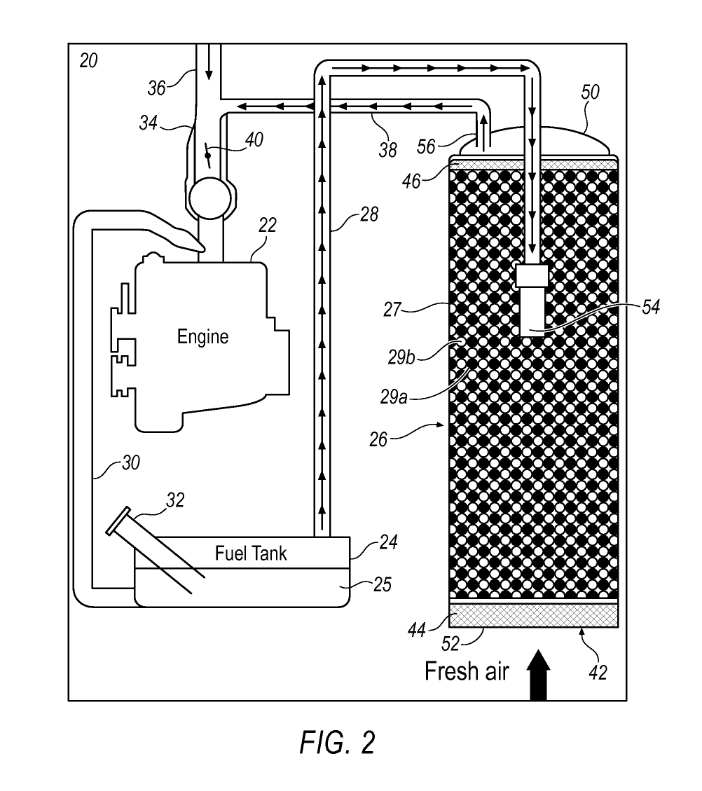

FIGS. 1 and 2 illustrate a vehicle system 20 including an engine 22, fuel tank 24 and evaporative emission control system 26. Fuel tank 24 with liquid fuel 25 is connected to and in fluid communication with engine 22 via fuel line 30. Fuel tank 24 includes fill line 32 for adding fuel. Fuel vapor inlet line 28 connects fuel tank 24 to evaporative emission control system 26 such that volatile fuel components from fuel tank 24 can be vented to evaporative emission control system 26. As will be explained below, it has been discovered that the inclusion of a bed of catalyst and fuel vapor adsorbent in evaporation control system 26 provides efficient removal of volatile hydrocarbons generated in fuel tank 24. It should be noted that the components of FIGS. 1 and 2 are not drawn to scale. In particular, evaporative emission control system 26 has been enlarged to better illustrate its features.

Evaporative emission control system 26 includes a vapor outlet line 38 that is connected to an engine air intake line 36. Air intake line 36 and vapor outlet line 38 combine to form engine air inlet line 34. Valve 40 controls the flow of air and/or desorbed vapor components (see below) supplied from evaporative emission control system 26 into engine 22. Valve 40 may be operated by a suitable control system (not shown) to regulate the flow of air into engine 22.

FIG. 1 depicts vehicle system 20 when engine 22 is not operating. When engine 22 is not operating, volatile fuel components may build up in tank 24, causing a rise in tank pressure. The build up of such volatile components may be especially pronounced when vehicle system 20 is exposed to warm temperatures due to the resulting rise in the vapor pressure of fuel in fuel tank 24. To maintain a safe tank pressure, it is desirable to vent such volatile fuel components from tank 24. However, due to environmental concerns, venting tank 24 directly to the atmosphere is undesirable. Accordingly, volatile components from tank 24 are vented to evaporative emission control system 26 when engine 22 is not operating. Evaporative emission control system 26 removes hydrocarbon components from the vented volatile materials and discharges a cleaned gas stream to the atmosphere with reduced levels of hydrocarbon. As illustrated in FIG. 2, when engine 22 is operating, hydrocarbons that were previously removed from the discharged gas are released to engine 22 via vapor outlet line 38 to be consumed during the engine's combustion process.

In the embodiment of FIGS. 1 and 2, evaporative emission control system 26 comprises canister 27 which is illustrated as having an elongated shape, including for example, a cylindrical or semi-cylindrical shape. Canister 27 has first end 50, second end 52, and a hollow interior with a bed of vapor contacting material 29 disposed therein. Canister 27 is preferably formed from a synthetic resin. In one exemplary illustration, canister 27 is formed from a polyamide such as nylon 66. In another example, canister 27 is formed from polypropylene. Although not specifically depicted in the figures, canister 27 is preferably configured for removable connection to fuel tank 24 and engine 22 to facilitate replacement of canister 27 if necessary.

Vapor contacting material 29 comprises a vapor storage medium, which in the illustrated system of FIGS. 1 and 2 is a fuel vapor adsorbent 29a. Vapor contacting material 29 also comprises catalyst 29b. Canister 27 includes a fuel vapor inlet 54, which in the exemplary system of FIGS. 1 and 2 is connected to fuel vapor inlet line 28 and disposed in the interior of canister 27 approximately at its lengthwise mid point. However, fuel vapor inlet 54 may be located elsewhere, such as proximate first end 50 of canister 27. In the illustration represented by FIGS. 1 and 2, canister 27 includes a single internal chamber in which vapor contacting material 29 is disposed. However, multiple chamber canister designs of the type known in the art may also be used.

Fuel vapor outlet 56 is also located at first end 50 of canister 27 and is connected to vapor outlet line 38. Canister 27 also may include filter 46 for filtering particulate matter from discharged vapors before they exit canister 27 through fuel vapor outlet 56 and fuel vapor outlet line 38. As explained below, in one preferred approach, fuel vapor contacting material 29 is granular in nature and may become entrained in the discharged vapor stream. Filter 46 reduces the amount of entrained particulates exiting evaporative emission control system 26. In one example, filter 46 is a screen member having a mesh size less than that of vapor contacting material 29. In another exemplary illustration, filter 46 is formed from urethane or non-woven fabric. Filter 46 also aids in retaining vapor contacting material 29 within canister 27.

Second end 52 of canister 27 also comprises a filter 44 which is similar to filter 46. In the illustrated system of FIG. 1, cleaned gas is discharged to atmosphere via discharge section 42 of filter 44. Filter 46 is preferably retained in place by suitable connection to canister 27. In the combined illustration of FIGS. 1 and 2, discharge section 42 comprises a portion of the face of filter 44 which is open to the atmosphere. However, a discharge pipe may also be configured at second end 52 of canister 27 to discharge cleaned gases therethrough. Discharge section 42 of filter 44 also acts as an inlet for fresh air that is pulled through evaporative emission control system 26 during a desorption/regeneration process when engine 22 is operating.

As indicated above, vapor contacting material 29 includes fuel vapor adsorbent 29a and at least one catalyst 29b. As shown in FIG. 1, when engine 22 is not operating, accumulated hydrocarbons in fuel tank 24 are vented to evaporative emission control system 26 via fuel vapor inlet line 28, as shown by a series of arrows in FIG. 1. Hydrocarbons are adsorbed to the fuel vapor adsorbent 29a until the adsorbent's working capacity is reached (i.e., saturation) so that gas discharged from cleaned gas discharge 42 is substantially reduced in hydrocarbon content. The adsorption process is exothermic (i.e., heat is released).

As shown in FIG. 2, when engine 22 is operated, the hydrocarbons which were adsorbed to fuel vapor adsorbent 29a are periodically desorbed. The desorption process is endothermic (i.e., heat is consumed). As engine 22 is operated, valve 40 is periodically opened to admit fresh air via air intake line 36 and air inlet line 34. In certain embodiments, the opening and closing of valve 40 is controlled by an on-board diagnostic system that is programmed to determine when desorption will occur. The intake of fresh air generates a vacuum condition in evaporative emission control system 26, thereby causing fresh air to be drawn into canister 27 via cleaned gas discharge/fresh air inlet 42. The fresh air desorbs hydrocarbons from fuel vapor adsorbent 29a, and the desorbed hydrocarbons exit evaporative emission control system 26 through fuel vapor outlet line 38. The air and desorbed hydrocarbons are routed to the air intake section of engine 22. Air intake line 36 is connected to fuel vapor outlet line 38 so that a combination of fresh air and desorbed hydrocarbons are fed to engine 22 through engine inlet line 34. In accordance with the foregoing, desorbed hydrocarbons are consumed in the combustion process when engine 22 is operating. As shown in FIG. 2, when engine 22 is operating, accumulated hydrocarbons in fuel tank 24 are preferably vented to evaporative emission control system 26 as is the case when engine 22 is not operating.

In one preferred approach, fuel vapor adsorbent 29a comprises activated carbon. As is known to those skilled in the art, activated carbons may be classified according to their “Butane Working Capacity” or “BWC,” which indicates their ability to adsorb butane under certain specified test conditions. The BWC is defined as the difference between the butane adsorbed at saturation and the butane retained per unit volume of carbon after a specified purge. Unless otherwise specified, as used herein the terms “Butane Working Capacity” or “BWC” refer to the ASTM (“American Society of Testing and Materials”) Standard D-5228 test method. In one exemplary illustration, fuel vapor adsorbent 29a comprises a BAX 1100 activated carbon supplied by the Specialty Chemicals Division of MeadWestvaco Corporation of Covington, Va. BAX 1100 activated carbon has a nominal BWC of 11.3 g butane/100 cc activated carbon. In another example, fuel vapor adsorbent 29a comprises a MeadWestvaco BAX 1500 activated carbon having a nominal BWC of 15.0 g butane/100 cc activated carbon. The foregoing activated carbon products are exemplary only, and other fuel vapor adsorbents with other BWC values may also be used without departing from the spirit and scope of the invention.

Fuel vapor adsorbents such as activated carbon are typically expensive and constitute a substantial portion of the cost of evaporative emission control system 26. Thus, it would be beneficial to provide a vapor contacting material 29 that reduces the required amount of fuel vapor adsorbent 29a. It has been discovered that catalyst 29b can be added to fuel vapor adsorbent 29a to increase the amount of hydrocarbon that can be removed for a given amount of fuel vapor adsorbent 29a.

As used herein the term “catalyst” refers to a single constituent or a combination of constituents that improves the efficiency (i.e., the amount of hydrocarbon adsorbed/desorbed per unit volume of fuel vapor adsorbent 29a) of the hydrocarbon adsorption/desorption process and is not limited to materials that increase the rate of reaction.

Catalyst 29b preferably has a specific heat that is higher than the specific heat of fuel vapor adsorbent 29a. As a result, the overall specific heat of vapor contacting material 29 will be higher than if fuel vapor adsorbent 29a alone were used. Without wishing to be bound by any theory, it is believed that the increase in specific heat reduces the overall temperature increase in vapor contacting material 29 during adsorption/loading in accordance with the following relationship:

ΔH_{adsorption}=CpΔT−Qₗₒₛₛₑₛ (1)

In formula 1, ΔH_{adsorption} refers to the heat released due to adsorption. Cp refers to the specific heat of vapor contacting material 29. ΔT refers to the temperature increase in vapor contacting material 29, and Qₗₒₛₛₑₛ refers to heat losses to the surroundings. As the temperature of vapor contacting material 29 increases, it is believed that the efficiency of adsorption decreases while heat losses to the surroundings increase. Accordingly, it is further believed that by increasing the overall specific heat of vapor contacting material 29, more heat can be recovered from the adsorption process and made available for use in desorption. It is believed that the increase in available heat for desorption increases the extent of desorption, thereby making additional active sites on fuel vapor adsorbent 29a available to adsorb hydrocarbons in subsequent adsorption/loading cycles. Thus, for a given volume of fuel vapor adsorbent, more hydrocarbon can be adsorbed and desorbed. Put differently, by increasing the specific heat of vapor contacting material 29, a desired level of hydrocarbon removal can be achieved using less fuel vapor adsorbent 29a.

Catalyst 29b preferably comprises a polymeric material. In one exemplary illustration, the polymeric material is a polyamide (nylon) resin. In another example, the polymeric material is polypropylene. Catalyst 29b may also include additives such as heat stabilizers, dyes, impact modifiers, etc. However, such additives are preferably present in a sufficiently small amount so that their effect on adsorption and/or desorption of hydrocarbon vapors is negligible. In certain exemplary envisioned approaches, fuel vapor adsorbent 29a comprises an activated carbon having a specific heat of from about 0.2 to less than 0.4 cal/g/° C., and catalyst 29b has a specific heat of at least about 0.4 cal/g/° C. Of course, catalyst specific heats greater than 0.4 cal/g/° C. are also suitable. In an illustrated example wherein fuel vapor adsorbent 29a is MeadWestvaco BAX 1100 activated carbon, fuel vapor adsorbent 29a has a specific heat of about 0.31 cal/g/° C.

In another exemplary approach, catalyst 29b comprises unfilled nylon 66. As is known to those skilled in the art, nylon 66 is a condensation polymer of hexamethylene diamene and adipic acid. One suitable type of nylon 66 is Zytel® 103FHS, a product of the DuPont Company. Zytel® 103FHS is a heat stabilized lubricated nylon 66 with a specific heat of about 0.4 cal/g/° C. In yet another example, catalyst 29b is polypropylene.

It has been further discovered that the relative amounts of catalyst 29b and fuel vapor adsorbent 29a affect the adsorption capacity of fuel vapor adsorbent 29a, i.e., the amount of hydrocarbon adsorbed per unit volume of adsorbent. More specifically, as increasing amounts of catalyst 29b are added to a given amount of fuel vapor adsorbent 29a, the adsorption capacity of fuel vapor adsorbent 29a per unit volume increases. However, it has also been observed that the percentage change in adsorption capacity ultimately reaches a maximum and then declines as the percentage of catalyst is increased.

The volume of catalyst 29b as a percentage of the total volume of vapor contacting material 29 ranges generally from about one (1) to about forty (40) percent. In a preferred illustration, catalyst 29b is present in a volume ranging from about ten (10) to about twenty (20) percent by volume of the total volume of vapor contacting material 29. In an especially preferred approach currently contemplated, catalyst 29b comprises about fifteen (15) percent by volume of the total volume of vapor contacting material 29.

Fuel vapor adsorbent 29a and catalyst 29b are preferably provided in pelletized or granular form to allow them to be mixed together. In one envisioned example, catalyst 29b comprises non-uniform granules that are about 0.5 mm to about 5 mm in length, width, and thickness. However, a variety of granule shapes and sizes may be used. In an example wherein catalyst 29b comprises Zytel® 103FHS, catalyst 29b comprises non-uniform granules of about 1 mm to about 3 mm in overall length, width, and thickness. In certain embodiments, fuel vapor adsorbent 29a preferably comprises pellets having a length that is from about 2 mm to about 5 mm and a diameter that is from about 2.1 mm to about 2.5 mm. In another example wherein fuel vapor adsorbent 29a comprises pelletized Westvaco BAX1100 activated carbon, fuel vapor adsorbent 29a has a mesh size of about 2 mm and a mean particle diameter of about 2.2 mm. However, granular fuel vapor adsorbents such as granular activated carbon may also be used. The foregoing are merely exemplary illustrations; a wide variety of pellet and granule geometries and sizes can be used.

In one currently preferred illustration, vapor contacting material 29 comprises a substantially homogeneous mixture of fuel vapor adsorbent 29a and catalyst 29b. The use of a substantially homogeneous mixture is believed to allow catalyst 29b to more uniformly absorb the heat generated when hydrocarbons are adsorbed by fuel vapor adsorbent 29a and to more uniformly release the absorbed heat during a desorption process. In turn, the efficiency gains in adsorption and desorption are more uniformly distributed throughout vapor contacting material 29, thereby minimizing the occurrence of localized hot spots that experience reduced adsorption capacity.

A variety of different processes can be used to combine fuel vapor adsorbent 29a and catalyst 29b. In one embodiment, catalyst 29b is ratably injected into a flow of fuel adsorbent 29a to obtain the desired relative amounts of each component. The combined flow of fuel vapor adsorbent 29a and catalyst 29b may be directly injected into individual canisters, or it may be injected into secondary receptacles from which the canisters are subsequently filled.

Table 1 presents adsorption data for various relative amounts of fuel vapor adsorbent 29a and catalyst 29b at a constant volume of fuel vapor adsorbent 29a. Butane Working Capacity values were calculated for four different volume percentages of catalyst: 0%, 10%, 15%, and 20%. The fuel vapor adsorbent 29a that was used was Westvaco BAX1100 activated carbon. The catalyst 29b that was used was Zytel® 103FHS nylon 66. At each different percentage of catalyst 29b, fresh activated carbon and nylon 66 were mixed and added to a test canister to obtain a bed of vapor contacting material 29 comprising a substantially homogeneous mixture of activated carbon and nylon 66.

TABLE 1

| | | | BWC (grams | |
|---|---|---|---|---|
| | | | adsorbed | % Change in |
| | Volume | | butane per | BWC versus |
| | Percentage | Adsorbed | liter | 0% catalyst |
| | of Nylon 66 | Butane (grams) | carbon) | data in row 1 |
| 1 | 0 | 124.29 | 54.04 | 0 |
| 2 | 10 | 127.65 | 55.50 | 2.7 |
| 3 | 15 | 135.90 | 59.09 | 9.34 |
| 4 | 20 | 135.31 | 58.83 | 8.87 |

In generating the data in Table 1, the ASTM D-5228 test method was not used. Instead, a 50/50 mixture (by volume) of butane and nitrogen was fed to the test canister until a saturation condition was observed in which 2 g of butane broke through the bed. To desorb the adsorbed hydrocarbons, 300 BV (“bed volume,” where 1 BV equals the volume occupied by vapor contacting material 29) of dry air was fed to the test canister at a flow rate of 22.7 liters/minute. To account for aging effects, at every different percentage of catalyst, the adsorption/loading and desorption/purging cycles were performed 13 times. At the 12^{th} and 13^{th} cycles, an adsorbed butane value was determined by calculating the difference between the amount of butane adsorbed at saturation (i.e., when 2 g of butane broke through the bed) and following purge. Average values for the amount of adsorbed butane at the 12^{th} and 13^{th} cycles were calculated and appear in column 2 of the table. The adsorbed butane was then divided by the volume of carbon (which was held constant at 2.3 liters) to obtain a BWC value in units of g/liter carbon. The BWC values for the various amounts of catalyst were compared to the zero catalyst BWC data to determine the percentage change in BWC for that amount of catalyst.

As the data in Table 1 indicate, as the amount of nylon 66 was increased, the Butane Working Capacity of the activated carbon increased, indicating that the addition of nylon 66 yielded more efficient adsorption for a given amount of carbon. While the data in Table 1 show a continual increase in Butane Working Capacity as the amount of catalyst is increased, the percentage increase exhibits a maximum at about fifteen (15) volume percent of catalyst. Thus, the further addition of catalyst would likely result in progressively smaller incremental gains in Butane Working Capacity.

As Table 1 suggests, by adding a catalyst that increases the overall specific heat of vapor contacting material 29, a desired amount of hydrocarbon adsorption can be achieved using less fuel vapor adsorbent. For example, in the illustrative approaches used to generate Table 1, the addition of fifteen (15) percent (by volume) of catalyst provided a 9.34 percent change in Butane Working Capacity. Thus, at fifteen (15) volume percent catalyst, the amount of fuel vapor adsorbent needed to remove a target amount of hydrocarbon is reduced by over nine (9) percent. Many polymeric catalysts are more readily available, including from recycled materials, than are fuel vapor adsorbents such as activated carbon. Thus, by using polymeric catalysts and decreasing the required amount of fuel vapor adsorbent, the overall cost of evaporative emission control system 26 may be correspondingly reduced.

The present invention has been particularly shown and described with reference to the foregoing examples, which are merely illustrative of the currently envisioned best modes for carrying out the invention. It should be understood by those skilled in the art that various alternatives to the illustrated approaches described herein may be employed in practicing the invention without departing from the spirit and scope of the invention as defined in the following claims. The illustrations given above should be understood to include all novel and non-obvious combinations of elements described herein, and claims may be presented in this or a later application to any novel and non-obvious combination of these elements. Moreover, the foregoing examples are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A evaporative emission control system comprising a polymeric catalyst.

2. The evaporative emission control system of claim 1, wherein the polymeric catalyst is a polyamide.

3. The evaporative emission control system of claim 1, further comprising a fuel vapor adsorbing material.

4. The evaporative emission control system of claim 3, wherein the fuel vapor adsorbing material is activated carbon.

5. The evaporative emission control system of claim 3, wherein the specific heat of the fuel vapor adsorbing material is less than the specific heat of the polymeric catalyst.

6. The evaporative emission control system of claim 3, wherein the polymeric catalyst is present in a volume ranging from about one to about forty percent of the total volume of fuel vapor adsorbing material and polymeric catalyst.

7. The evaporative emission control system of claim 3, wherein the fuel vapor adsorbing material and the polymeric catalyst are substantially homogeneously mixed.

8. The evaporative emission control system of claim 3, wherein the polymeric catalyst material is not chemically bonded to the fuel vapor adsorbing material.

9. The evaporative emission control system of claim 1, wherein the polymeric catalyst material has a specific heat of at least about 0.4 cal/g/° C.

10. An evaporative emission control system, comprising:
a fuel vapor adsorbing material and a catalyst, wherein the catalyst has a specific heat of at least about 0.4 cal/g/° C.

11. The evaporative emission control system of claim 10, wherein the specific heat of the catalyst is greater than the specific heat of the fuel vapor adsorbing material.

12. The evaporative emission control system of claim 10, wherein the catalyst is polymeric.

13. The evaporative emission control system of claim 12, wherein the polymeric catalyst is a polyamide.

14. The evaporative emission control system of claim 10, wherein the catalyst is present in a volume ranging from about one to about forty percent of the total volume of fuel vapor adsorbent and catalyst.

15. The evaporative emission control system of claim 10, wherein the fuel vapor adsorbing material and the catalyst material are substantially homogeneously mixed.

16. The evaporative emission control system of claim 10, wherein the fuel vapor adsorbing material and the catalyst material are not chemically bonded to one another.

17. An evaporative emission control system, comprising:
a fuel vapor adsorbent material mixed with at least one catalyst such that the fuel vapor adsorbent and the at least one catalyst are not chemically bonded to one another.

18. The evaporative emission control system of claim 17, wherein the specific heat of the at least one catalyst is greater than the specific heat of the fuel vapor adsorbent.

19. The evaporative emission control system of claim 17, wherein the at least one catalyst is polymeric.

20. The evaporative emission control system of claim 19, wherein the at least one catalyst is a polyamide.

21. The evaporative emission control system of claim 17, wherein the at least one catalyst has a specific heat of at least about 0.4 cal/g/° C.

22. The evaporative emission control system of claim 17, wherein the fuel vapor adsorbent material and the at least one catalyst are substantially homogeneously mixed.

23. The evaporative emission control system of claim 17, wherein the at least one catalyst is present in a volume ranging from about one to about forty percent of the total volume of the combined fuel vapor adsorbent and catalyst.

24. An evaporative emission control system, comprising:
a canister having a fuel tank inlet, and an air inlet;
activated carbon having a specific heat; and
a polymeric catalyst having a specific heat that is greater than the specific heat of the activated carbon, wherein the activated carbon and the polymeric catalyst are disposed in the canister.

25. The evaporative emission control system of claim 24, wherein the polymeric catalyst is a polyamide.
